(19) United States
(12) Patent Application Publication
(10) Pub. No.: US 2007/0251441 A1
(43) Pub. Date: Nov. 1, 2007

(54) Boat attachable light

(76) Inventor: David L. Herndon, Fort Walton Beach, FL (US)

Correspondence Address: Peter Loffler, P.O. Box 1001, Niceville, FL, 32588-1001, US

(21) Appl. No.: 11/799,529

(22) Filed: May 1, 2007

Related U.S. Application Data
(60) Provisional application No. 60/796,403, filed on May 1, 2006.

(51) Int. Cl. B63B 17/00; A01K 75/02; B63B 35/14; F21V 33/00

(52) U.S. Cl. 114/343; 43/17.5; 114/255; 362/253

(57) ABSTRACT

A light system that is pivotally attachable to a boat has a body member that floats on the surface of the water and has at least one light received within an opening thereat, the light shining down into the water toward the water body's floor in order to illuminate the contents thereat. A pair of poles, which may be telescoping, are attached to the body member, alone or with a connector, with the opposite ends of the poles pivotally attached to the boat, either by passing a bolt through the poles and the boat's sides, or to brackets attached to the boat, or by having these ends of the poles curled and clipped onto the boat. A wire passes through the poles and is electrically connected to the lights with the ends of the wire attached to the boat's battery via battery clips.

This application claims the benefit of provisional patent application No. 60/796,403 filed on May 1, 2006, which provisional application is incorporated herein by reference.

### BACKGROUND OF THE INVENTION

1. Field of the Invention

The present invention relates to a light that is attachable to a boat, which light is used to illuminate below the water line during flounder fishing or crabbing.

2. Background of the Prior Art

Flounder and crab each hide in the sand on the floor of a body of water for protection from predators. As flounder fishing are nighttime sports, the fisherman must be able to see the flounder or crab in order to be able to gig the flounder or net the crab. While some fishermen rely simply on the light of the moon for the necessary lighting, the moon is only sufficiently bright a few days each month. If a bright moon is hidden by clouds, the moon is of little value. Accordingly, people who engage in flounder fishing and crabbing rely on a light that shines down into the water in order to illuminate the floor of the body of water so that the bounty can be spotted and harvested. Many fishermen rely on either a handheld spotlight or a boat mounted spot light for such illumination. The spotlight has sufficient candle power to pierce down into the water and shine onto the water body's floor. Although spotlights work reasonably well, some of the light issued by the spotlight reflects off of the water's surface making seeing down into the water more difficult especially if there is light chop on the water.

To address this problem, underwater-based lights have been developed. These lights are placed into the water below the water line so that the water surface does not reflect any light. However, such lights tend to be unusually expensive to purchase and are subject to damage if an underwater obstruction is encountered.

Others have dedicated spotlights installed in their boats, which lights are disposed below the water line. These lights, which are generally flush with the remainder of the hull, are not prone to damage from debris encounters. However, due to the need to install the lights into the hull of the boat and to electrically connect the lights to a source of electrical power, such installation tends to be very expensive. Additionally, if the lights are not correctly installed, the boat may leak. As a result, many boat owners are reluctant to make such an installation.

What is needed is a device that allows a fisherman to be able to illuminate a water body's floor in order to reveal flounder or crab that hide at the floor. Such a device must not reflect light off of the water's surface and should be of relatively simple design and construction so as to be readily affordable to a large segment of the consumers for such devices. The device must not be prone to damage from underwater debris encounters and must not require an alteration to the hull of the boat.

### SUMMARY OF THE INVENTION

The boat attachable light of the present invention addresses the aforementioned needs in the art by providing a light that allows a fisherman to be able to illuminate a water body's floor during flounder fishing or crabbing. The boat attachable light has its light beam entirely beneath the water's surface so that light issued by the device does not reflect off of water's surface. The present invention is of relatively simple design and construction so as to be readily inexpensive to manufacture and install making the device readily affordable to a large segment of the consumers for these types of devices. The boat attachable light is not prone to damage from underwater debris encounters and does not require an alteration to the hull of the boat.

The boat attachable light of the present invention is comprised of a water buoyant body member that has an upper surface and a lower surface. At least one opening passes between the upper surface and the lower surface. A light is disposed in each opening such that each light shines downwardly from the lower surface. A pole system has a first pole with a first distal end and a first proximal end, a second pole with a second distal end and a second proximal end, and a connector that connects the first distal end and the second distal end. The pole system is attached to the upper surface of the body member. A wire passes through the first pole and the second pole (and the connector if used) and is electrically connected to each light. The wire is also connected to a source of electrical power for energizing the light. The first proximal end is pivotally attached to a boat and the second proximal end is pivotally attached to the boat. The first proximal end of the first pole may be curled and the second proximal end of the second pole may be curled, these curled ends being removably clipped onto the boat. A first battery clip is located on a first end of the wire while a second battery clip is located on a second end of the wire such that the first battery clip is attached to a positive terminal of a battery and the second battery clip is attached to a negative terminal of a battery.

### BRIEF DESCRIPTION OF THE DRAWINGS

FIG. 1 is an environmental view of multiple boat attachable lights of the present invention attached to various points on a boat.

FIG. 2 is a detail view of one of the boat attachable lights attached to the boat using a bracket system.

FIG. 3 is a side view of the boat attachable light attached to the boat using a bolt and nut system.

FIG. 4 is a side elevation view, partially cutaway, of the boat attachable light.

FIG. 5 is a top plan view of the boat attachable light.

FIG. 6 is a perspective view, from the bottom, of the boat attachable light.

FIG. 7 is an exploded view of the boat attachable light.

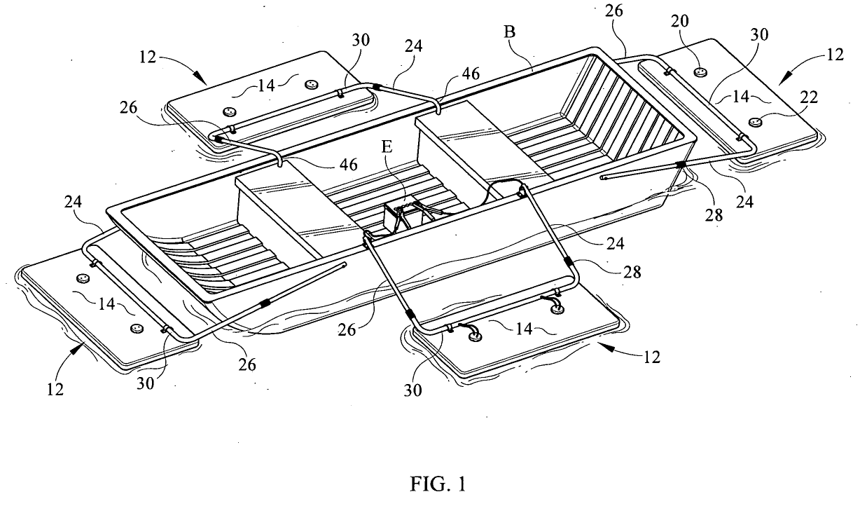

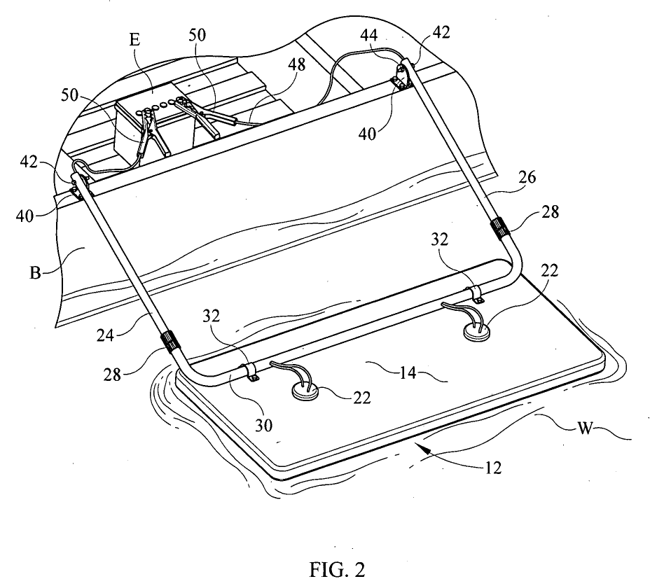

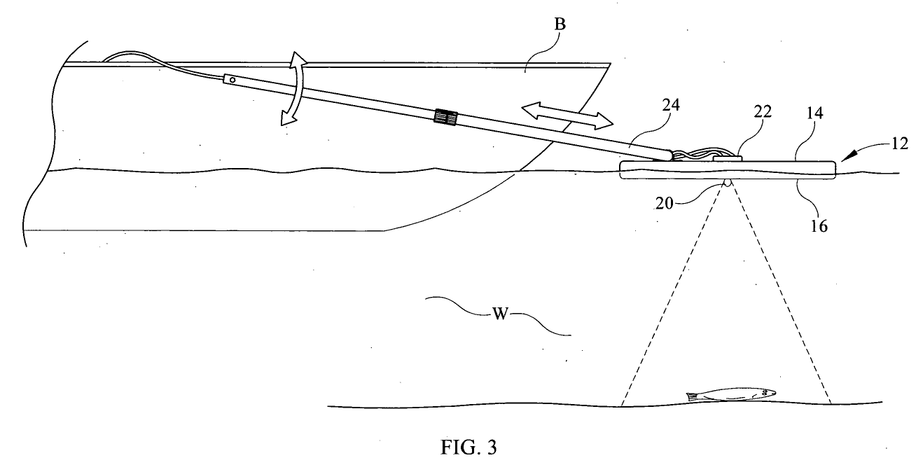

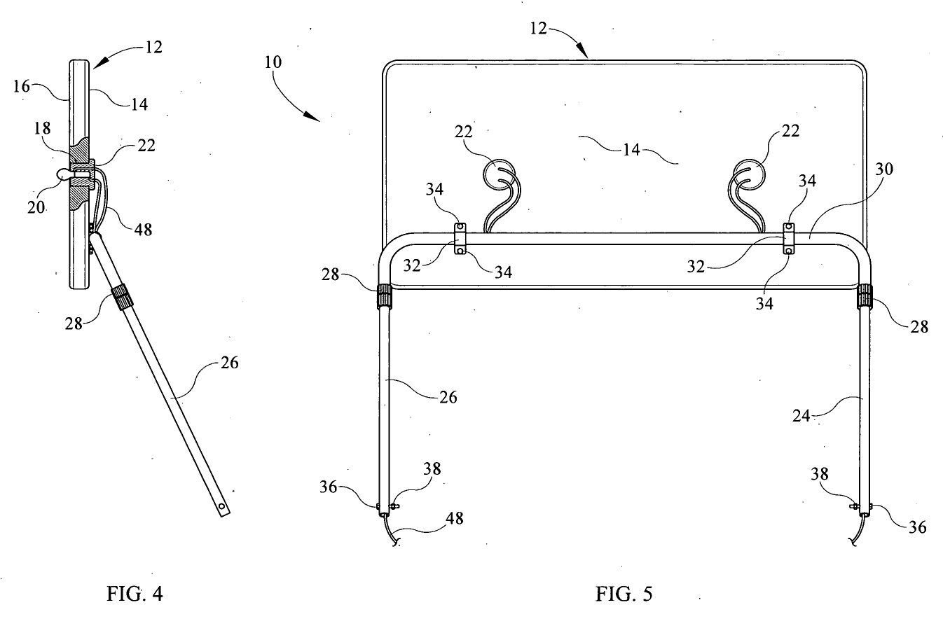

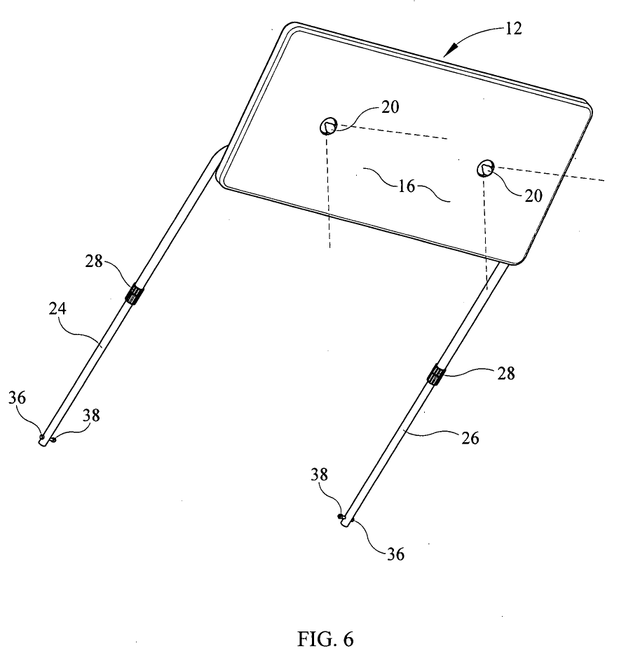

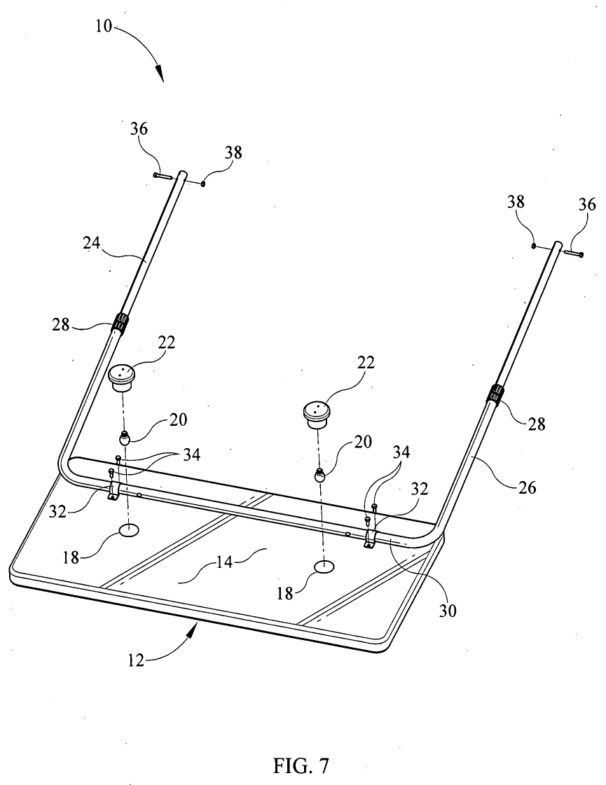

Similar reference numerals refer to similar parts throughout the several views of the drawings.

### DESCRIPTION OF THE PREFERRED EMBODIMENT

Referring now to the drawings, it is seen that the boat attachable light of the present invention, generally denoted by reference numeral 10 is comprised of a body member 12 that is made from a water buoyant material such as closed cell foam, Styrofoam, wood etc., the body member having an upper surface 14 and a lower surface 16. The dimensions of the body member 12 and specifically the width are dependent on the size of the boat B to which the device 10 attaches. At least one opening 18 passes between the upper surface 14 and the lower surface of the body member 12. A light 20 is received within each opening 18, the light being any appropriate light such as a Halogen light, a strong LED, an incandescent, etc. The light 20 can be friction held within its respective opening 18 or can be secured thereto in any other appropriate fashion such as by the screwing the light 20 thereinto, by the use of an adhesive, putty, tape, etc., or the base 22 of the light 20 can be wider than the opening 18 so that the base 22 rests on the upper surface 14 of the body member 12 with the light protruding down through the lower surface 16, the base 22 may or not be adhered thereat. A first pole 24 has a distal end attached to the upper surface 14 (or side edge) of the body member 12 while a second pole 26 has a distal end similarly attached to the body member 12 on the other side thereof. The poles 24 and 26 may be of fixed length or, as illustrated, may be telescoping in appropriate fashion in order to change the lengths of the poles 24 and 26 to accommodate boats B of differing sizes. Telescoping of the pole may be in any appropriate fashion such as by having a connector located medially along each pole 24 and 26 which connector can be disconnected and an additional section added thereat, by the use of the illustrated nested sections with a twist lock 28 located at the nesting intersection, etc. A connector 30 may connect the distal ends of the two poles 24 and 26 although the connector 30 is not necessary. If desired, the connector 30 may also be telescoping to accommodate boats B of differing widths and may be monolithic with at less part of each pole 24 and 26. The poles 24 and 26 and the connector 30 are each made from a hollow lightweight tube material such as PVC or aluminum. The poles 24 and 26 and/or the connector 30 are attached to the upper surface 14 of the body member 12 in any appropriate fashion for the material used for the body member 12 such as by the use of the illustrated clips 32 that encompass the connector 30, the clips screwed into the upper surface 14 of the body member 12 with appropriate screws 34.

The proximal end of the first pole 24 and the proximate end of the second pole 26 are each pivotally attached to the sides of the boat B above the water W surface. Pivotal attachment can be accomplished in any appropriate fashion such as by drilling a hole into each side of the boat and passing a bolt 36 through a hole on the proximal end of each pole 24 and 26 and its corresponding respective hole on the boat B with a nut 38 holding each bolt 36 therein. Alternately, a bracket 40 can be attached to the top of the sides of the boat B with each bracket 40 having an opening that corresponds with a respective opening on the proximal ends of each pole 24 and 26 and a bolt passing therethrough and a nut 44 holding each bolt 42. As a further alternative, each proximal end of the poles 24 and 26 may have a curled section 46 so that the device 10 is hooked onto the sides of the boat B via the curled sections 46 in similar fashion to a removable ladder.

Wire 48 passes through the poles 24 and 26 and through the connector 30 and is electrically connected to each light 20, the lights 20, if more than one is used, are connected in series. The ends of wire 48 each have a battery clip 50 thereon that is attached to the positive and negative terminals of the boat's battery E. The electrical system is appropriately sealed in order to prevent shorting out of the lights 20.

In order to use the boat attachable light 10 of the present invention, each pole 24 and 26 is extended to its desired length (if telescoping) and the connector 30 is extended to its desired width (if telescoping) and the poles 24 and 26 and/or the connector 30 is attached to the upper surface 14 of the body member 12 in appropriate fashion. The proximal ends of each pole 24 and 26 are pivotally attached to the boat B in appropriate fashion as discussed above and one of the battery clips 50 is attached to the positive terminal of the battery E while the other battery clip 50 is attached to the negative terminal of the battery E thereby energizing the lights 20. When the boat B is out on the water W, the body member 12 floats on the surface of the water W and the lights shine downwardly into the water W in order to illuminate the water's contents. The pivoting nature of the poles' 24 and 26 attachments to the boat B help the body member 12 so float.

While the invention has been particularly shown and described with reference to an embodiment thereof, it will be appreciated by those skilled in the art that various changes in form and detail may be made without departing from the spirit and scope of the invention.

I claim:

1. A light system comprising:
a water buoyant body member having an upper surface and a lower surface;
an opening passing between the upper surface and the lower surface;
a light disposed in the opening such that the light shines downwardly from the lower surface;
a first pole having a first distal end attached to the body member and a first proximal end;
a second pole having a second distal end attached to the body member and a second proximal end;
a wire passing through the first pole and the second pole and electrically connected to the light, the wire also connected to a source of electrical power for energizing the light; and
wherein the first proximal end is adapted to be pivotally attached to a boat and the second proximal end is adapted to be pivotally attached to the boat.

2. The light system as in claim 1 wherein the first distal end is attached to the upper surface and the second distal end is attached to the upper surface.

3. The light system as in claim 1 further comprising a connector connecting the first distal end and the second distal end.

4. The light system as in claim 1 wherein the first proximal end is curled and the second proximal end is curled.

5. The light system as in claim 1 further comprising:
a first battery clip located on a first end of the wire;
a second battery clip located on a second end of the wire; and
such that the first battery clip is attached to a positive terminal of a battery and the second battery clip is attached to a negative terminal of the battery.

6. The light system as in claim 1 in combination with the boat.

7. The light system as in claim 6 wherein the first distal end is attached to the upper surface and the second distal end is attached to the upper surface.

8. The light system as in claim 6 further comprising a connector connecting the first distal end and the second distal end.

9. The light system as in claim 6 wherein the first proximal end is curled and the second proximal end is curled.

10. The light system as in claim 6 further comprising:
a first battery clip located on a first end of the wire;
a second battery clip located on a second end of the wire; and
such that the first battery clip is attached to a positive terminal of a battery and the second battery clip is attached to a negative terminal of the battery.

11. A light system comprising:
a water buoyant body member having an upper surface and a lower surface;
an opening passing between the upper surface and the lower surface;
a light disposed in the opening such that the light shines downwardly from the lower surface;
a pole system having a first pole that has a first distal end and a first proximal end, the pole system further having a second pole that has a second distal end and a second proximal end and the pole system having a connector that connects the first distal end and the second distal end, the pole system attached to the upper surface of the body member;
a wire passing through the first pole and the second pole and electrically connected to the light, the wire also connected to a source of electrical power for energizing the light; and
wherein the first proximal end is adapted to be pivotally attached to a boat and the second proximal end is adapted to be pivotally attached to the boat.

12. The light system as in claim 11 wherein the first proximal end is curled and the second proximal end is curled.

13. The light system as in claim 11 further comprising:
a first battery clip located on a first end of the wire;
a second battery clip located on a second end of the wire; and
such that the first battery clip is attached to a positive terminal of a battery and the second battery clip is attached to a negative terminal of the battery.

14. The light system as in claim 11 in combination with the boat.

15. The light system as in claim 14 wherein the first proximal end is curled and the second proximal end is curled.

16. The light system as in claim 14 further comprising:
a first battery clip located on a first end of the wire;
a second battery clip located on a second end of the wire; and
such that the first battery clip is attached to a positive terminal of a battery and the second battery clip is attached to a negative terminal of the battery.
